(19) United States
(12) Patent Application Publication
(10) Pub. No.: US 2021/0146311 A1
(43) Pub. Date: May 20, 2021

(54) Spiral-wound membrane structure

(71) Applicants: Dachuan Li, Xiamen (CN); Li Lv, Xiamen (CN); Shuang Yu, Xiamen (CN); Mang Lu, Xiamen (CN); JianYong Yan, Xiamen (CN)

(72) Inventors: Dachuan Li, Xiamen (CN); Li Lv, Xiamen (CN); Shuang Yu, Xiamen (CN); Mang Lu, Xiamen (CN); JianYong Yan, Xiamen (CN)

(21) Appl. No.: 17/060,018

(22) Filed: Sep. 30, 2020

(30) Foreign Application Priority Data
Nov. 18, 2019 (CN) 201911127590.3

(51) Int. Cl. B01D 63/10; B01D 61/02; B01D 61/14

(52) U.S. Cl. CPC B01D 63/10; B01D 61/025; B01D 2313/04; B01D 61/145; B01D 2313/21; B01D 61/027

(57) ABSTRACT

A spiral-wound membrane structure includes a central pipe and a film roll. The central pipe comprises a filter body and end covers separately connected to two ends of the filter body. A passage is formed in the center of the filter body, and two ends of the filter body are embedded in the end covers to be bonded on and sealed by the end covers. The film roll includes a guide cloth, a membrane and a mesh. The film roll is wound on the central pipe. The central pipe is directly made of a filter material, can be used as a pre-filter or post-filter, and can be matched with the film roll in the spiral-wound membrane structure to form a highly-integrated two-in-one composite filter. The composite filter can be mounted on a water purifier.

### BACKGROUND OF THE INVENTION

### 1. Technical Field

The invention relates to a kind of spiral-wound membrane structure.

### 2. Description of Related Art

Most existing reverse-osmosis (RO) water purifiers adopting multi-filtration comprise a pre-filter, an RO filter and a post-filter. Due to the configuration of too many filters, the water purifiers are more complicated in structure and larger in size. Composite filters which have an optimized overall structure and can reduce the production cost have gradually become a development trend.

### BRIEF SUMMARY OF THE INVENTION

To solve the above technical problems, the objective of the invention is to provide a spiral-wound membrane structure.

The invention is implemented through the following technical solution: a spiral-wound membrane structure comprises a central pipe and a film roll, wherein the central pipe comprises a filter body and end covers separately connected to two ends of the filter body, a passage is formed in the center of the filter body, and two ends of the filter body are inlaid in the end covers and are bonded on and sealed by the end covers; and the film roll comprises a guide cloth, a membrane and a mesh, and the film roll is wound on the central pipe.

Preferably, glue regions on two sides of the film roll correspond to outer circular regions of one end cover, and the film roll is bonded on and sealed by the end covers.

Preferably, 1-15 film rolls are sequentially wound on the central pipe.

Preferably, the filter body is made of a filter material.

Preferably, the film roll has a front side and a reverse side, and the front side or the reverse side of the film roll is wound on the central pipe.

Preferably, after the front side of the film roll is wound on the central pipe, the mesh is disposed on the front side of the membrane, and a pure water passage is formed on the reverse side of the membrane, and the guide cloth is disposed in the pure water passage.

Preferably, after the reverse side of the film roll is wound on the central pipe, the guide cloth is disposed on an inner layer, and the membrane and the mesh are sequentially disposed on an outer side of the guide cloth.

Preferably, the membrane is a RO membrane, a nano-filtration film or an ultra-filtration film.

Preferably, the filter body adopts single-filtration or multi-filtration.

Preferably, the filter body consists of a filter material and rids, and the ribs are embedded in the filter body to form a cylinder structure.

Preferably, the spiral-wound membrane structure further comprises an annular rib, wherein the ribs are connected with the annular rib, a receding part is vertically formed in an outer wall of the central pipe, a groove is circumferentially formed in the outer wall of the central pipe, and the ribs and the annular rib are separately matched with the receding part and the groove to form the cylinder structure.

The spiral-wound membrane structure of the invention has the following beneficial effects:

1. The central pipe of the invention is directly made of a filter material, can be used as a pre-filter or a post-filter, and can be matched with the film roll in the spiral-wound membrane structure to form a highly-integrated two-in-one composite filter, so that when the two-in-one composite filter structure is assembled to a water purifier, the structure of the water purifier can be simpler and can save space, and the filter cost and the overall production cost of the water purifier can be further reduced.

2. The central pipe of the invention is directly made of a filter material, can replace original all-plastic central pipes without a filter function, and the filter material can fulfill a filter function and can serve as the spiral-wound membrane central pipe; moreover, the ribs are inlaid in the surface of the central pipe body to structurally reinforce the filter material, so that the strength of the filter material is improved to satisfy the strength requirement for rolling film elements, and the ribs can also be used to connect film components such as the membrane and the guide cloth.

### BRIEF DESCRIPTION OF THE SEVERAL VIEWS OF THE DRAWINGS

To gain a better explanation of the technical solution of the invention, the accompanying drawings required for the description of the embodiments of the invention or the prior art are briefly described below. Clearly, the accompanying drawings in the following description are merely for illustrating some embodiments of the invention, and those ordinarily skilled in the art can obtain other accompanying drawings according to the following ones without creative labor.

FIG. 1 is a sectional view of a spiral-wound membrane structure of the invention.

FIG. 2 is a sectional view of a single-filtration central pipe of the invention.

FIG. 3 is a sectional view of a multi-filtration central pipe of the invention.

FIG. 4 is a front view and top view of a filter body of the invention.

FIG. 5 is a sectional view along A-A′ in FIG. 4.

FIG. 6 is a front view and top view of the connection of ribs and an annular rib of the invention.

FIG. 7 is a structural view of the spiral-wound membrane structure in an unfolded state of the invention.

FIG. 8 is a structural view of the spiral-wound membrane structure used as a pre-filter of the invention.

FIG. 9 is a schematic diagram of a water path of the spiral-wound membrane structure used as the pre-filter of the invention.

FIG. 10 is a structural view of the spiral-wound membrane structure used as a post-filter of the invention.

FIG. 11 is a schematic diagram of a water path of the spiral-wound membrane structure used as a post-filter of the invention.

### DETAILED DESCRIPTION OF THE INVENTION

The technical solution of the embodiments of the invention will be clearly and completely described below in conjunction with the accompanying drawings of the embodiments. Clearly, the embodiments in the following description are merely illustrative ones, and are not all possible ones of the invention. All other embodiments obtained by those ordinarily skilled in the art on the basis of the following ones without creative labor should also fall within the protection scope of the invention.

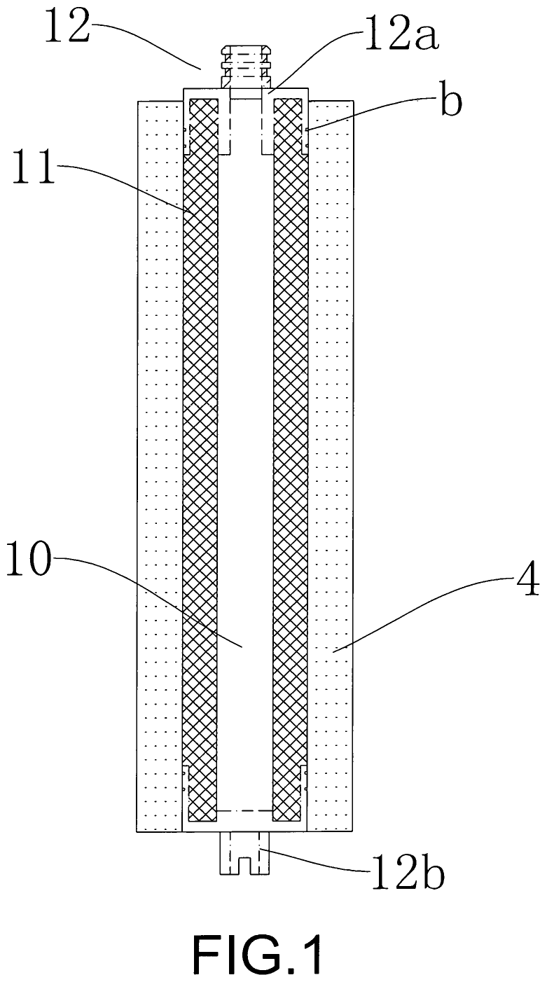

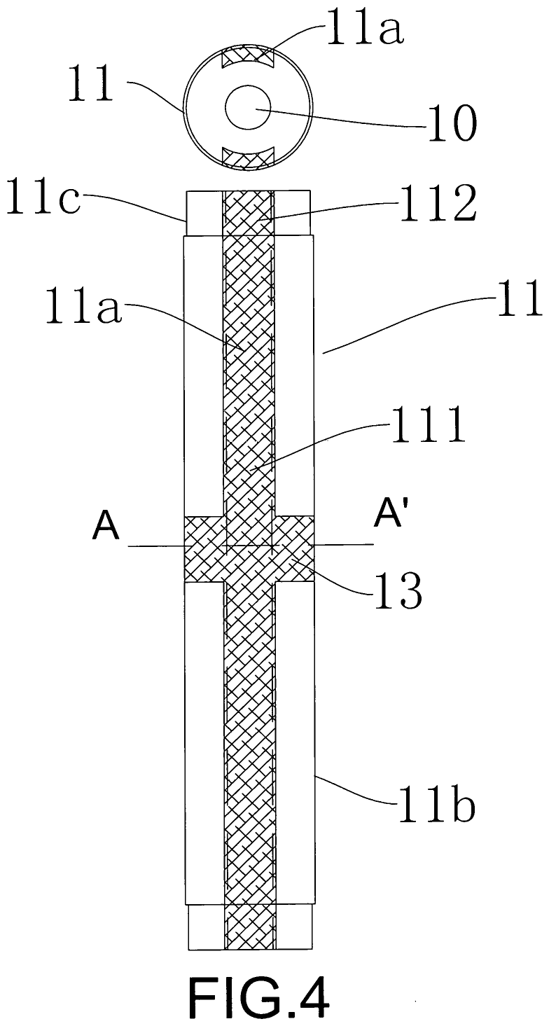

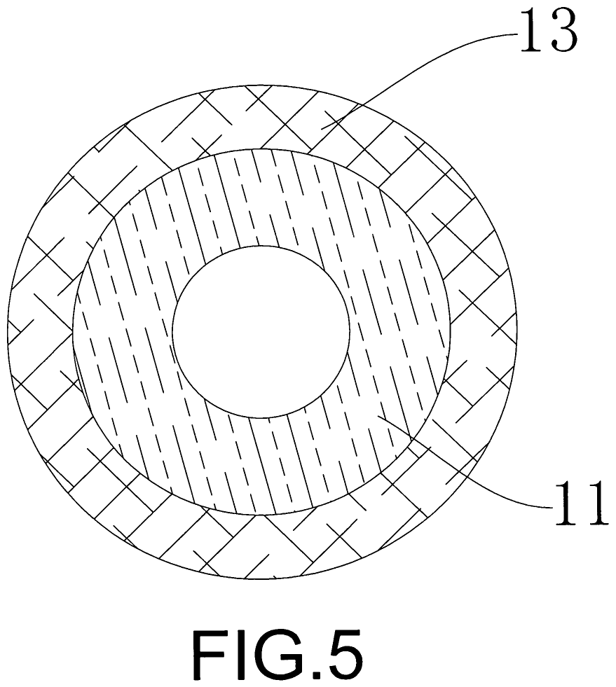

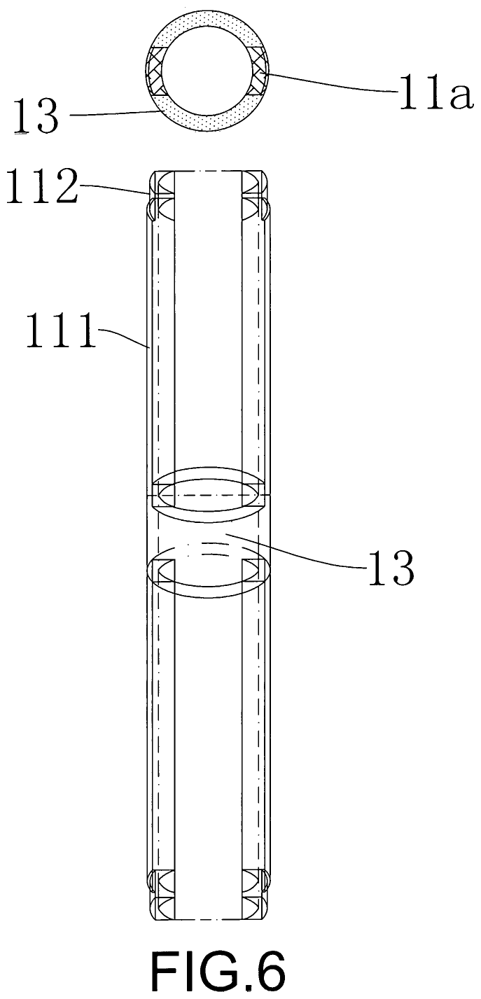

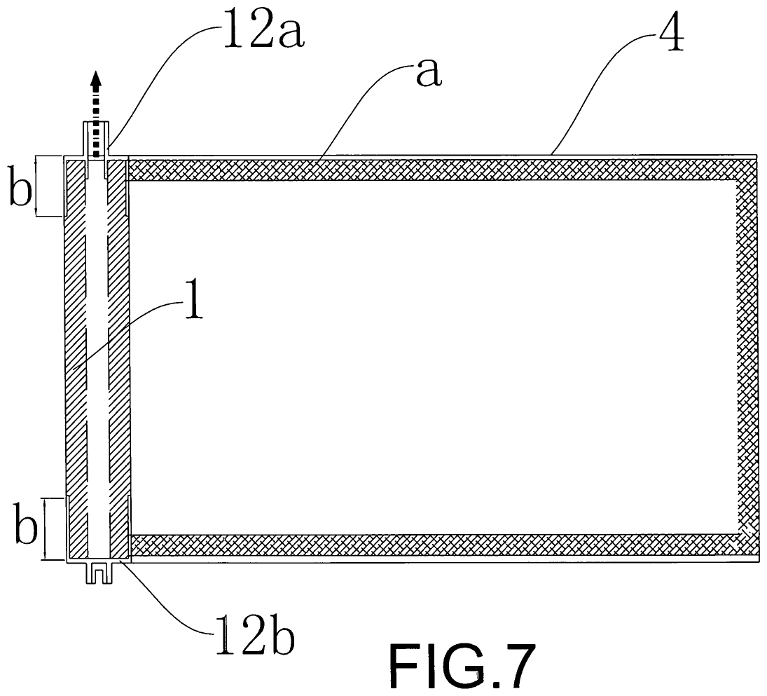

Referring to FIG. 1 to FIG. 11, a spiral-wound membrane structure comprises a central pipe 1 and a film roll 4, wherein the central pipe 1 consists of a filter body 11 and end covers 12, the filter body 11 is made of a filter material, a passage 10 formed in the center of the filter body 11, two ends of the filter body 11 are embedded in the end covers 12 to be bonded on and sealed by the end covers 12, the end covers include an upper end cover 12a and a lower end cover 12b, a hole is formed in the upper end cover 12a, and the lower end cover 12b seals one end of the filter body 11; the film roll 4 comprises a guide cloth 41, a membrane 42 and a mesh 43, wherein the membrane 42 is a RO membrane, a nano-filtration membrane or an ultra-filtration membrane, and a front side 4a or a reverse side 4b of the film roll is wound on the central pipe 1; glue regions a are arranged on two sides of the film roll 4 and correspond to outer circular regions a of the upper end cover 12a or the lower end cover 12b, and the film roll 4 is bonded on and seals the outer circular regions b of the end cover, that is, after the film roll is wound on the central pipe, projections of the glue regions a of the film roll are located in the outer circular regions b to realize a using effect the same as that of existing common central pipes, so that it is ensured that the central pipe can be sealed by the film roll after the film roll is wound on the central pipe. Preferably, 1-15 film rollers 4 are wound around the central pipe 1 in a certain sequence.

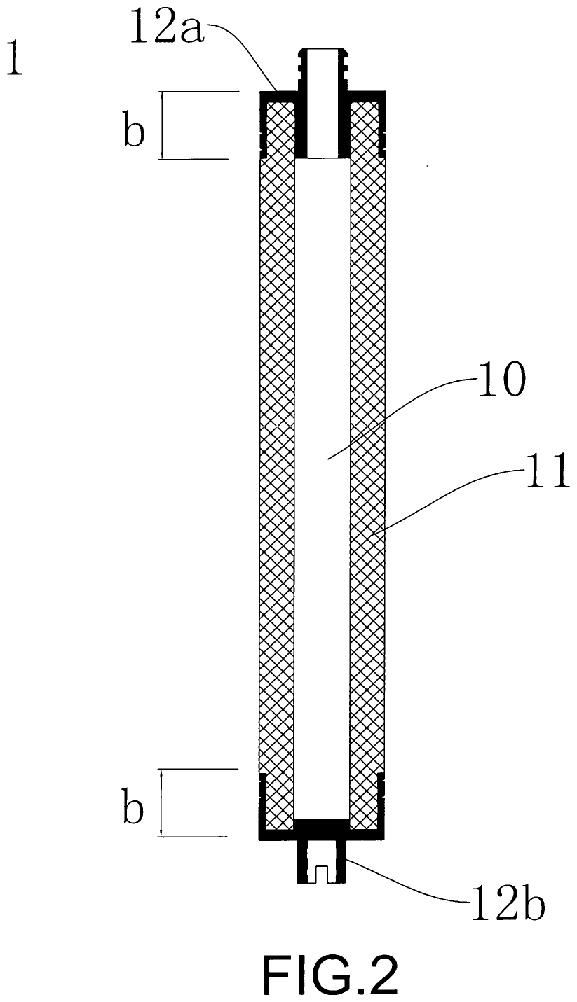

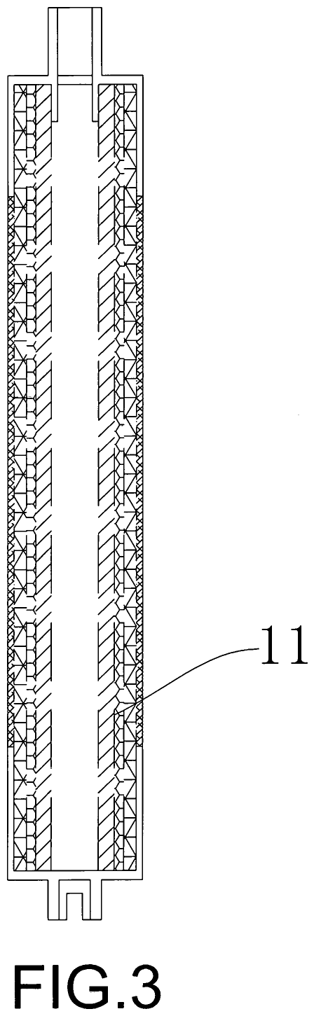

Referring to the figures, the central pipe 1 consists of the filter body 11 and the end covers 12, wherein the passage 10 is formed in the middle of the central pipe 1 to allow raw water to inflow or to allow purified water to outflow to be used; the filter body 11 has a filter function and may be any one of materials with a filter function such as a carbon rod, a PP wool or PP powder compacted pipe, a PE compacted pipe, a hybrid material compacted pipe, an ACF rolled fabric, a PP rolled fabric, a graphene compacted pipe, a rolled fiber and a non-woven fabric, and a single-filtration central pipe may be directly made of one filter material (as shown in FIG. 2) or a multi-filtration central pipe may be formed by combining multiple filter materials (as shown in FIG. 3). The central pipe of the invention is directly made of the filter material, so that the central pipe has a filter function and can replace central pipes without a filter function in the prior art, and water can directly penetrate into the central pipe which directly made of the filter material and having the filter function, without drilling holes in the surface of the central pipe. The central pipe of the invention is directly made of the filter material and can replace original all-plastic central pipes without a filter function, so that the filter material can fulfill the filter function and can serve as the roller film central pipe.

In a preferred embodiment, the filter body 11 consists of a filter material and ribs 11a for supporting, wherein the ribs 11a are embedded in the filter body 11 to form a cylinder structure. The ribs 11a are embedded in the central pipe 1 to form a cylinder structure having a surface provided with the ribs. For example, referring to FIG. 3 to FIG. 6, a receding part is vertically formed in the outer wall of the central pipe 1, and the ribs 11a are embedded in the receding part to form a cylinder structure. In another preferred embodiment, the ribs 11a have a certain length which is smaller than the overall height of the filter body 11. Two ribs are illustrated in the drawings of this embodiment, and the two ribs are symmetrically distributed on two opposite sides of the central pipe 1. Clearly, in other embodiments, the number of the ribs is 1-20, that is, the number of the ribs is 20 at most. The ribs can provide connection points for subsequent film rolling to realize connection with the guide cloth or the mesh when the film is rolled, and the ribs can also reinforce the filter body to prevent the central pipe from breaking.

Wherein, the ribs 11a may be embedded in the filter body by integrated formation, for example, when prepared, the ribs are placed in a mold in advance, then the filter material is injected into the mold, after that, the filter material and the ribs are compacted and sintered, and finally, the end covers are assembled to form the central pipe with the filter function. In another embodiment, modular embedding may be directly adopted, that is, the ribs are embedded into the filter material in a specific shape to form the filter body with a water filtering function by means of the filter material, and then, the end covers are assembled to form the central pipe. According to the invention, the ribs are inlaid in the surface of the central pipe to structurally reinforce the filter material, so that the strength of the filter material is improved to satisfy the strength requirement for rolling film elements, and the ribs can also be used to connect film components such as the membrane and the guide cloth.

In another preferred embodiment, no rib is arranged on the filter body 11 of the central pipe, and the filter body 11 is matched with the end covers 3 to reach the strength required by the central pipe, wherein the filter body is one or more of a carbon rod, a PP melt-blown pipe, and a PP compacted pipe.

Preferably, the filter body 11 has a main body part 11b and end parts 11c located at upper and lower ends of the main body part 11b, wherein the end parts 11c are concaved with respect to the main body part 11b; each rib 11a has a main rib part 111 and rib ends 112 located at upper and lower ends of the main rib part 111, wherein the main rib part 111 and the rib ends 112 correspond to the main body part 11b and the ends 11c separately, the rib ends 112 are concaved with respect to the main rib part 111 to form steps matched with the filter body, so that the end covers can be exactly inlaid in the rib ends or the ends of the central pipe to form a cylinder; and the outer circular regions b of the end cover can be cooperatively bonded on and seal the glue regions a of the film roll. According to the invention, the end covers with the outer circular regions are integrally inlaid in the filter body to realize sealing and can provide sealing sites for the membrane.

Furthermore, the central pipe 1 further comprises an annular rib 13 connected with the ribs 11a, a groove is circumferentially formed in the outer wall of the filter body 11, the annular rib 13 is matched in shape with the groove to form the cylindrical central pipe; the annular rib 13 can be disposed at any position of the filter body 11 and is mainly used to share force applied to the central pipe and the ribs so as to improve the strength of the central pipe. Preferably, the number of the annular ribs connected with the ribs is 20 at most. Or, the annular rib may not be configured. According to the invention, the annular rib can share force borne by the ribs when the ribs are too long, so that the force can be dispersed to the whole central pipe in the subsequent film rolling process, and fracture or breakage of the central pipe caused by excessive local stress is avoided.

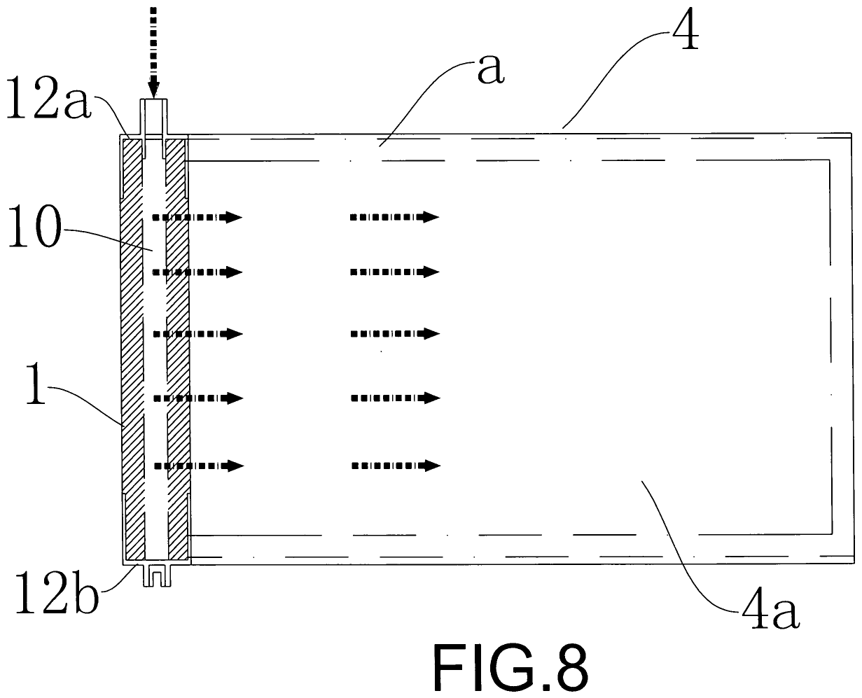

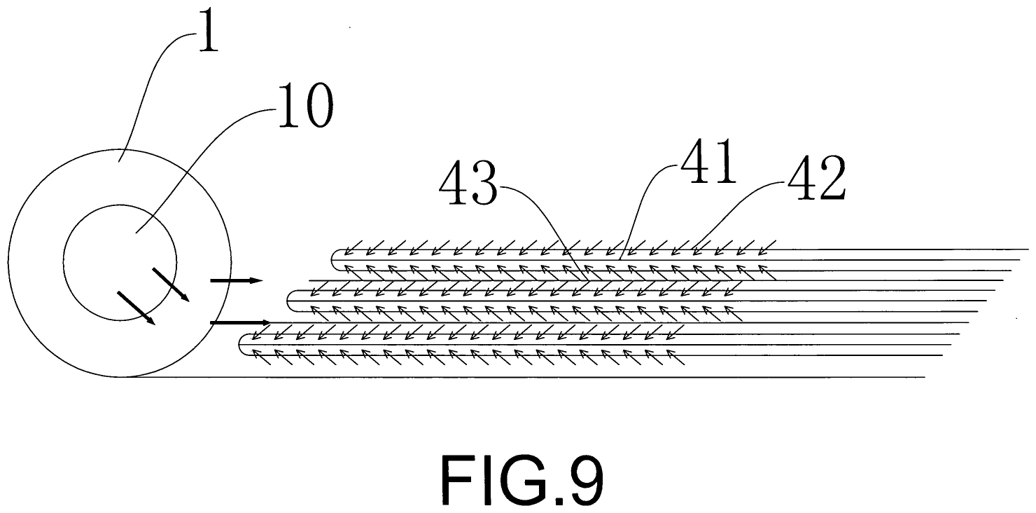

In one specific embodiment, when applied to the spiral-wound membrane structure, the central pipe 1 can be used as a pre-filter. Referring to FIG. 8 and FIG. 9, when the central pipe 1 is used as the pre-filter, water enters the passage 10 of the central pipe via the hole formed in the upper end cover 12a, flows through the filter body 11 to be filtered, and finally is discharged. The spiral-wound membrane structure comprises the central pipe 1 and the film roll 4, wherein the front side 4a of the film roll 4 is wound on the central pipe 1; after the film roll 4 is wound on the central pipe 1, the mesh 43 is disposed on the front side of membrane 42 (desalination layer) which is arranged on the outer side of the mesh 43, a pure water passage is formed in the reverse side of the membrane 42, and the guide cloth 41 is disposed in the pure water passage, that is, the guide cloth 41 is disposed on the other side of the membrane 42. In this way, after raw water flows into the filter body 11 from the passage 10 to be filtered, the water flows towards the membrane 42 to be filtered along the mesh 43 (the arrow direction in the figure), pure water obtained after filtration flows out along the guide cloth in the pure water passage, and non-filtered water will flow out along the mesh 43 to be treated as wastewater.

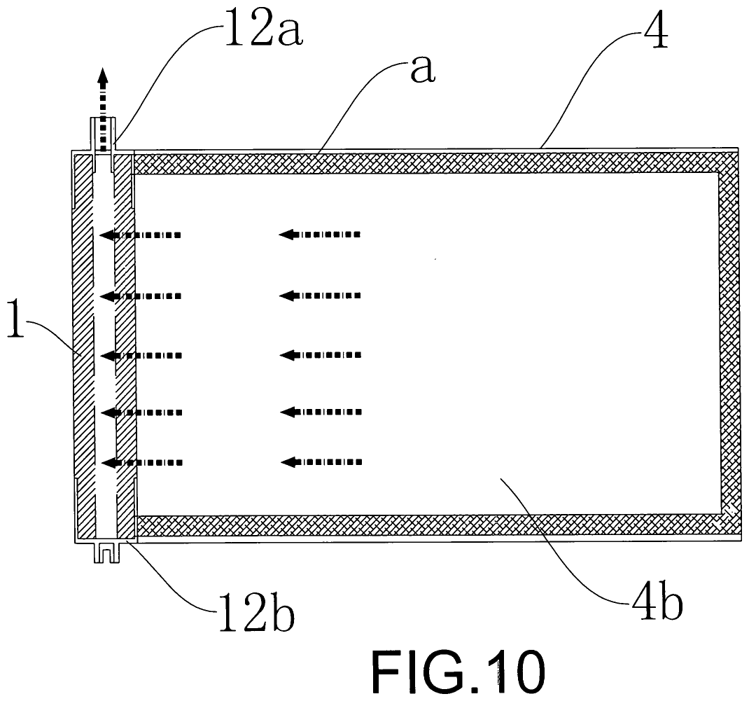

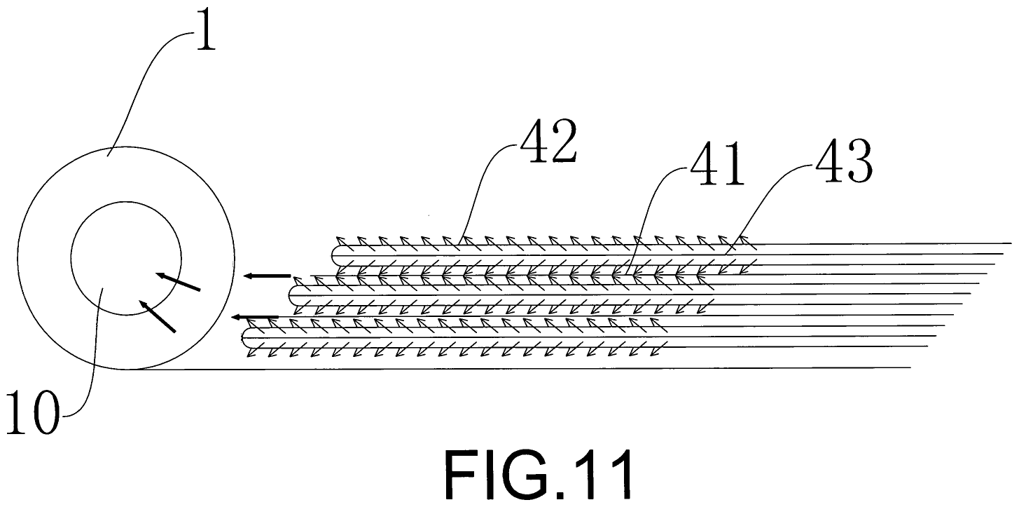

In another preferred embodiment, when applied to the spiral-wound membrane structure, the central pipe 1 can be used as a post-filter. Referring to FIG. 10 and FIG. 11, when the central pipe is used as the post-filter, water flows into the central pipe 1 from the outside, and finally obtained pure water flows out via the hole formed in the upper end cover 12a to be used by users. The spiral-wound membrane structure comprises the central pipe 1 and a film roll 4, wherein the reverse side 4b of the film roll 4 is wound on the central pipe 1; after the film roll is wound on the central pipe, the guide cloth 41 is disposed on an inner layer, the membrane 42 is disposed on the outer side of the guide cloth 41, and the mesh 43 is disposed on the outer side of the membrane 42; and in this case, water from the outside flows along the mesh 43 (arrow direction in the figures), passes through the membrane 42 to be filtered, then flows towards the central pipe along the guide cloth 41, and is further purified after being filtered by the central pipe 1 used as the post-filter, finally obtained pure water flows out along the passage 10 of the central pipe 10 to be used by people, and non-purified concentrated water flows out along the mesh 43. The central pipe of the invention is directly made of a filter material, can replace existing all-plastic central pipes, and has a filter function which cannot be realized by the existing central pipes; moreover, the central pipe can be used as a pre-filter or a post-filter and can be matched with the film roll in the spiral-wound membrane structure to form a highly-integrated two-in-one composite filter, so that when the two-in-one composite filter structure is assembled to a water purifier, the structure of the water purifier can be simpler and can save space, and the filter cost and the overall production cost of the water purifier can be further reduced.

While the invention has been described in terms of preferred embodiments, those skilled in the art will recognize that the invention can be practiced with modifications within the spirit and scope of the appended claims.

What is claimed is:

1. A spiral-wound membrane structure, comprising a central pipe and a film roll, wherein the central pipe comprises a filter body and end covers separately connected to two ends of the filter body, a passage is formed in a center of the filter body, and two ends of the filter body are inlaid in the end covers and are bonded on and sealed by the end covers; and the film roll comprises a guide cloth, a membrane and a mesh, and the film roll is wound on the central pipe.

2. The spiral-wound membrane structure of claim 1, wherein glue regions on two sides of the film roll correspond to outer circular regions of one said end cover, and the film roll is bonded on and sealed by the end covers.

3. The spiral-wound membrane structure of claim 1, wherein 1-15 said film rolls are sequentially wound on the central pipe.

4. The spiral-wound membrane structure of claim 1, wherein the filter body is made of a filter material.

5. The spiral-wound membrane structure of claim 1, wherein the film roll has a front side and a reverse side, and the front side or the reverse side of the film roll is wound on the central pipe.

6. The spiral-wound membrane structure of claim 5, wherein after the front side of the film roll is wound on the central pipe, the mesh is disposed on a front side of the membrane, and a pure water passage is formed on a reverse side of the membrane, and the guide cloth is disposed in the pure water passage.

7. The spiral-wound membrane structure of claim 5, wherein after the reverse side of the film roll is wound on the central pipe, the guide cloth is disposed on an inner layer, and the membrane and the mesh are sequentially disposed on an outer side of the guide cloth.

8. The spiral-wound membrane structure of claim 1, wherein the membrane is a RO membrane, a nano-filtration film or an ultra-filtration film.

9. The spiral-wound membrane structure of claim 1, wherein the filter body consists of a filter material and rids, and the ribs are embedded in the filter body to form a cylinder structure.

10. The spiral-wound membrane structure of claim 9, further comprising an annular rib, wherein the ribs are connected with the annular rib, a receding part is vertically formed in an outer wall of the central pipe, a groove is circumferentially formed in the outer wall of the central pipe, and the ribs and the annular rib are separately matched with the receding part and the groove to form the cylinder structure.
